(19) United States
(12) Patent Application Publication
(10) Pub. No.: US 2007/0260511 A1
(43) Pub. Date: Nov. 8, 2007

(54) System and method for providing rewards including visible indicia thereon to a user to encourage physical activity and to encourage the accurate reporting of physical activity

(75) Inventor: Neil Carmichael Bender II, Wilmington, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Image Products, Inc.

(21) Appl. No.: 11/417,226

(22) Filed: May 3, 2006

(51) Int. Cl. G06Q 30/00

(52) U.S. Cl. 705/14

(57) ABSTRACT

The present invention provides an exercise incentive method for encouraging physical activity by a user and accurate reporting of such physical activity to a business entity that may be at least partially responsible for health care costs incurred by the user. More specifically, the present invention provides rewards to the user for reporting participation in an exercise program. The rewards include indicia thereon indicating the participation of the user in the exercise program so as to encourage the user to accurately report such participation. The present invention also provides steps for administering the incentive method of the present invention on behalf of the business entity so as to reduce the burden of tracking, issuing, and redeeming incentives that may be issued to the customers.

### BACKGROUND OF THE INVENTION

1. Field of the Invention

The present invention relates to the field of incentive systems for providing rewards to users to reward participation in physical exercise and to encourage the accurate reporting of participation in physical exercise to a business entity such as a health insurer, employer, or health provider.

2. Description of Related Art

In an attempt to curtail increasing health care costs, a number of health insurance companies and self-insured employer health plans are providing incentives to customers in return for their participation in wellness programs. Such wellness programs may provide incentives to customers who complete periodic medical check-ups or who participate in a fitness program. Commonly offered incentives include frequent flier miles, retailer discounts, and “points” that may be earned in return for reporting a customer's participation in a qualifying wellness activity (such as a medical check-up). In addition, some employers have also attempted to ease their employees' access to wellness care by locating physicians' offices in their own facilities. However, this strategy often increases health care costs by making health care more conveniently available in cases where a condition may not warrant a visit to a physician's office.

While such conventional incentivized wellness programs may provide customers with generalized incentives such as redeemable “points” that may be incrementally earned for participation in wellness activities, such incentives are often not specifically linked to the wellness program. For example, the conventional wellness incentives do not include reward products that are “marked” with a logo indicating that the product was earned as a reward for reaching a specified wellness goal. Thus, conventional incentives do not include a mechanism for encouraging self-policing or “honest” reporting of participation in a wellness activity (such as a physical activity). Furthermore, conventional incentivized wellness programs fail to focus on a particularly quantifiable and/or verifiable wellness activity, such as participation in an exercise program, which may actually reduce health care costs incurred by a health insurance provider if the customer's fitness habits are successfully changed by the incentives. For example, most conventional incentivized wellness programs provide generic “points” for a wide spectrum of wellness activities, including eating healthy foods, attending medical check-ups, and physical activities. Thus, conventional programs may not encourage the establishment of a fitness regimen because so many alternative routes exist to obtain rewards, such as frequent visits to a doctor and/or daily consumption of the recommended daily allowance of fruits and vegetables. Customers participating in such unfocused incentivized wellness programs may thus earn rewards even while avoiding the most beneficial, quantifiable, and cost-reducing wellness activity: regular exercise.

Furthermore, conventional incentive systems also must be administered directly by the business entity. For example, a business entity, when offering wellness rewards and/or incentives, may be charged not only with storing rewards and/or gifts, but also shipping, distributing, and providing customer service with respect to the rewards. Thus, the use of conventional incentive programs may be labor-intensive and require special training and/or additional employee support. Furthermore, conventional incentivized wellness programs do not provide for follow-up surveys and/or tracking of individual customers in relation to reported wellness activities and redeemed rewards. Thus, a business entity administering a conventional incentivized wellness program may not have access to a direct comparison of the cost of administering the wellness program to the estimated health care cost savings due to one or more customers' reported and/or verified participation in the wellness program.

The limitations in conventional incentivized wellness programs may also create a burden on the systems of a business entity that seeks to encourage customers to participate in wellness activities (such as an exercise program). For example, the business entity may be required to display (via a specialized internet web page, for example) the rewards that may be available in return for participation in a specified set of wellness activities. The business entity may often be required to expend computing power to maintain and update an inventory of reward products.

Therefore, there exists a need for an improved incentive method and/or computer program product to solve the technical problems outlined above that are associated with conventional incentivized wellness programs. More particularly, there exists a need for a method for encouraging participation in a physical activity and for encouraging the accurate reporting of participation in the physical activity to a business entity. Furthermore, there exists a need for a turn-key physical activity reward method that reduces the burden on a business entity by: providing a display of available rewards based on a maintained inventory, providing third-party administration of rewards, providing accurate estimations of costs and health care savings realized by the rewards program, providing customer service for shipping and/or distributing the rewards, and/or providing other operational support for the rewards system.

### BRIEF SUMMARY OF THE INVENTION

The needs outlined above are met by the present invention which, in various embodiments, provides a method and/or computer program product that overcomes many of the technical problems discussed above, as well other technical problems, with regard to the encouragement of participation in a physical activity and the encouragement of the accurate reporting of participation in the physical activity to a business entity (such as a health care provider, for example). According to one embodiment of the present invention, the method and/or computer program product comprises steps for: receiving a plurality of reports of a participation of a user in a corresponding plurality of physical activities; issuing a plurality of credits to the user in response to the received plurality of reports; and redeeming a fixed number of the plurality of credits for a reward. The reward includes visible indicia thereon indicating the participation of the user in the plurality of physical activities so as to encourage the user to accurately report the participation in the plurality of physical activities. For example, the reward product may include a logo printed thereon indicating that the reward recipient customer is participating in a fitness program, such that the customer will be less likely to desire the reward if the customer is not actually participating and exhibiting the visible results (such as increased fitness and/or weight loss) stemming from regular participation in a physical activity.

In other embodiments, the redeeming step described above comprises requiring the user to select the reward from a plurality of rewards each having the visible indicia therein. In some additional embodiments, the method and/or computer program product further comprises maintaining an inventory of the plurality of rewards. According to such embodiments, the redeeming step further comprises requiring the user to select the reward from a subset of the plurality of rewards wherein the subset of the plurality of rewards is available in the maintained inventory. In some embodiments, the method and/or computer program product further comprises presenting the reward to the user via a display for displaying the reward in a redemption category corresponding to a value of the reward and the fixed number of the plurality of credits.

Some embodiments of the present invention also provide steps for administering the method embodiments of the present invention on behalf of the business entity. For example, some embodiments further comprise steps for: shipping the reward to the user on behalf of the business entity, and contacting the customer to confirm the redeeming and shipping steps. Some embodiments may further comprise performing steps for receiving an information data set corresponding to the user from the business entity such that the identity of the user may be corroborated and utilized to track the receiving, issuing, and redeeming steps further described herein.

In some embodiments, the method and/or computer program product further comprises steps for surveying the user to determine whether or not the method steps of the present invention are impacting the user's behavior and/or habits with respect to the establishment of a wellness routine (such as, for example, a fitness program). In some embodiments, the method and/or computer program product further comprises steps for administering a wellness survey to the user so as to solicit wellness data corresponding to the user; comparing the wellness data to the received plurality of reports of the participation of the user in the plurality of physical activities; and determining a trend in a fitness level of the user based at least in part on the comparison of the wellness data and the received plurality of reports. According to various embodiments, such wellness data may include, but is not limited to: body mass index (BMI); weight; height; cholesterol level; blood pressure; resting heart rate; and combinations of such wellness data types.

Some such embodiments may further comprise reporting the determined trend to the business entity. In some embodiments, wherein the business entity is at least partially responsible for health care costs incurred by the user (as, for example, a health insurer), the method may also further comprise steps for charging a service fee to the business entity for performing the receiving, issuing, redeeming, administering, comparing and determining steps; estimating a reduction in the health care costs incurred by the user using the determined trend; and reporting the estimated reduction in health care costs to the business entity such that the estimated reduction is comparable to the service fee.

Thus the methods and computer program products for encouraging physical activity and the accurate reporting of physical activity, as described in the embodiments of the present invention, provide many advantages that may include, but are not limited to: providing a program for incentivizing exercise that discourages participant “cheating” in reporting physical activity by offering rewards having visual indicia that indicate the participant is reporting participation in regular physical activity; providing an incentivized exercise program that helps to build exercise habits by requiring redemption of exercise “credits” at selected intervals that are known thresholds for habitual participation in a fitness program; providing an incentivized method for encouraging fitness (and consequently reducing health care costs) that is substantially “turn-key” such that a business entity may focus on their business while the incentive method is administered by a third party that may track and offer the rewards, and handle customer service issues related to the incentive program; and providing a wellness program that encourages quantifiable savings in health care costs via regular exercise and presents such quantifiable savings in reports to a business entity that is at least partially responsible for health care costs.

These advantages and others that will be evident to those skilled in the art are provided in the methods and computer program products of the present invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a flow chart of a method according to one embodiment of the present invention including the steps of receiving a report of physical activity, issuing credits for the received reports, and redeeming the credits for a reward.

FIG. 2 shows a flow chart of a method according to one embodiment of the present invention including a step for maintaining an inventory of rewards that are redeemable using the issued credits.

FIG. 3 shows a flow chart of a method according to one embodiment of the present invention including a step for displaying rewards to a user via a display.

FIG. 4 shows a flow chart of a method according to one embodiment of the present invention including steps for administering a wellness survey to a user to obtain wellness data, comparing the wellness data to the received reports, and determining a trend in the fitness level of the user.

FIG. 5 shows a flow chart of a method according to one embodiment of the present invention including a step for reporting the determined fitness level trend to a business entity (such as a health insurer).

FIG. 6 shows a flow chart of a method according to one embodiment of the present invention including steps for presenting the business entity comparable health care savings realized by the determined trend in the user fitness level relative to a fee charged for performing the method steps of the present invention.

FIG. 7 shows a flow chart of a method according to one embodiment of the present invention including steps for shipping and confirming the redemption of the reward to the customer.

FIG. 8 shows an input display according to one embodiment of the present invention wherein a customer may report participation in a physical activity.

FIG. 9 shows a display according to one embodiment of the present invention wherein a customer may view rewards already redeemed using issued credits.

FIG. 10 shows a display according to one embodiment of the present invention for displaying the reward in a redemption category corresponding to a value of the reward and the fixed number of credits required to redeem the reward.

FIG. 11 a display according to one embodiment of the present invention for displaying a history of the received reports of physical activity input by a customer.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The methods and computer program products of the present invention are described in a health insurance company incentives environment. It must be understood that this is only one example of the use of the present invention. Specifically, the methods and computer program products of the present invention can be adapted to any number of business entity types that may be at least partially responsible for health care costs of individuals (such as the users of the incentive program described herein). For example, the present invention may be used to encourage physical activity (and corresponding reductions in health care costs) among employees of a business entity that provides a self-insured employer health plan.

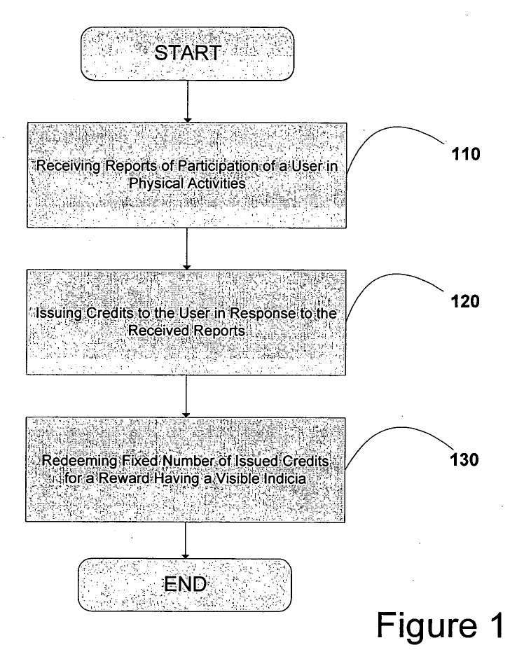

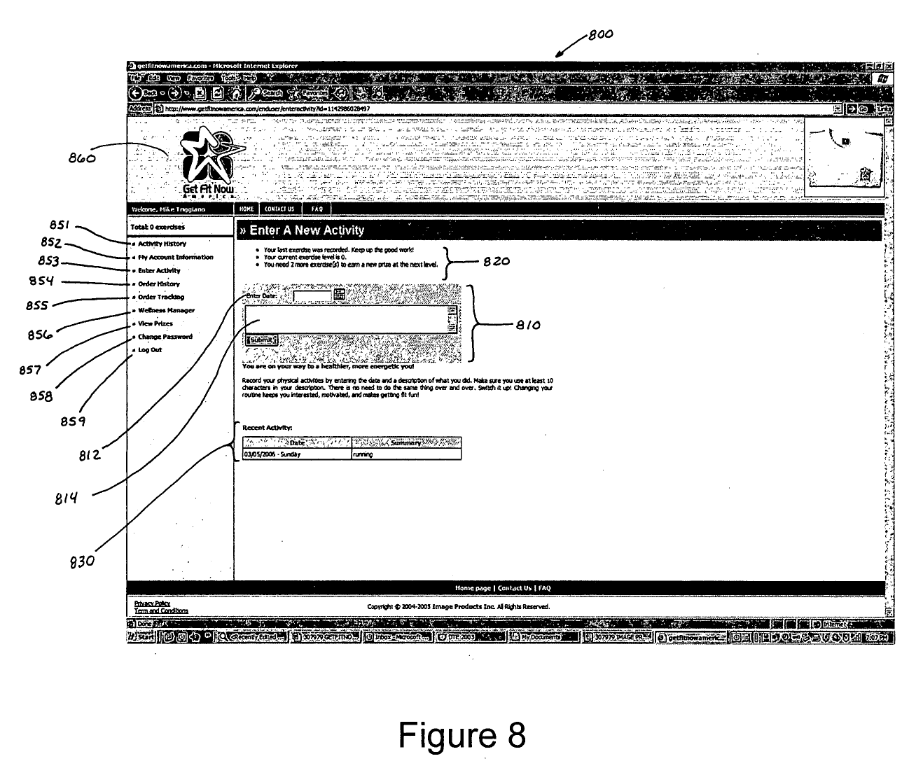

FIG. 1 shows a flow chart depicting a method according to one embodiment of the present invention for encouraging participation by a user in a physical activity and for encouraging the user's accurate reporting of participation in the physical activity to a business entity, such as, for example, a health insurer at least partially responsible for health care costs incurred by the user (which may be an individual insured by the business entity). The method comprises step 110 for receiving a plurality of reports of a participation of a user in a corresponding plurality of physical activities. The receiving step 110 may be accomplished, for example, via a web page display such as the reporting display 800 shown in FIG. 8. The reporting display 800 may be generated by a computer device (such as a server computer capable of hosting a web site) responsible for performing the various method steps described herein and may be interactively displayed to a user interface (such as a user's personal computer) via a network such as the internet. For example, in some embodiments, a user may log onto a secure web site (using a pre-set log-in identification produced by the business entity or by those performing the method and/or computer program product steps of the present invention) to access the reporting display 800 for reporting participation in a physical activity such that a computer device may receive (in step 110) the report of the participation of the user in a corresponding physical activity.

According to some embodiments the user may select and/or navigate to the reporting display 800 using at least one of the navigation links 851-859 shown in FIG. 8. Specifically, in some embodiments, the user may select the “enter activity” link 853 in order to input a report of a participation in a corresponding physical activity. For example, the receiving step 110 may comprise providing a reporting display 800 comprising at least one of an activity date dialog box 812 (for receiving a report from a user of a date of a participation in a corresponding physical activity) and a description dialog box 814 (for receiving a description from a user of the physical activity being reported). According to various embodiments, the description dialog box 814 may comprise a menu-type display such as a drop-down menu, such that the user may select from a plurality of pre-defined descriptions of various types of physical activity. According to other embodiments, the description dialog box. 814 may comprise a text input display for receiving a user-defined description of a physical activity.

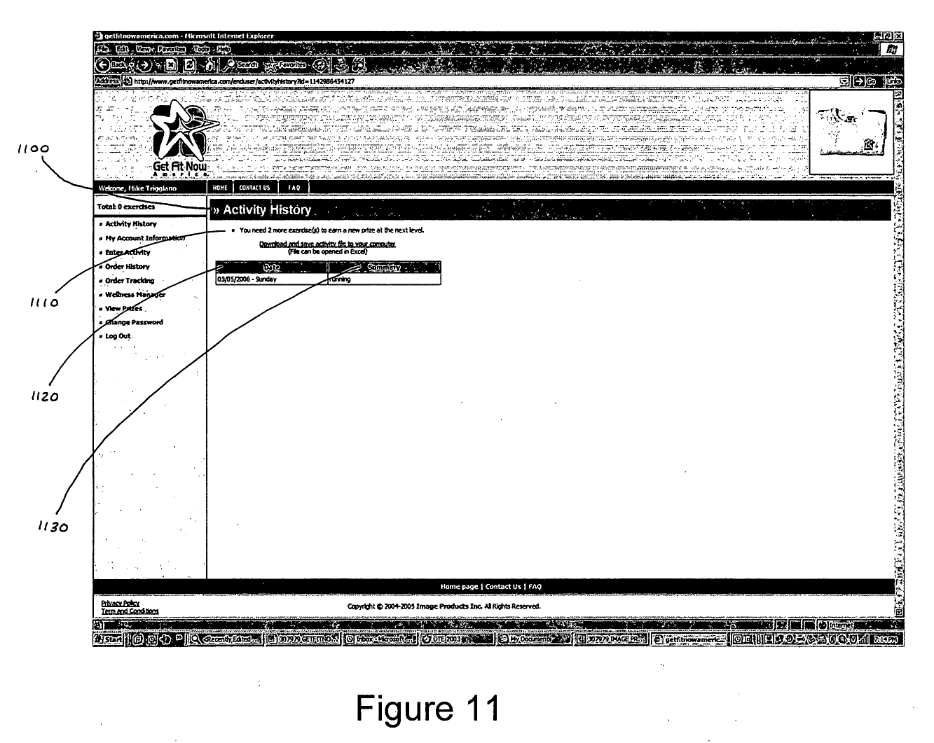

As shown in FIG. 8, the reporting display 800 generated as part of the receiving step 110 (according to some embodiments) may further comprise a status display 820 for summarizing the user's reports of recent participation in physical activity as logged by various previous receiving steps 110. For example, the status display 820 may include, but is not limited to: a display of the status of the received activity reports (i.e. whether or not the most recent reported physical activity has been recorded as part of the receiving step 110); a display of the user's current exercise level (for example, the number of reports of physical activity the user has successfully logged); and a display of the number of reports of physical activity that the user must successfully log in order to earn a reward at the next highest redemption category (as described further herein). Finally, as also shown in FIG. 8, the reporting display 800 may comprise a recent activity display 830 for showing recent reports of physical activity that have been logged by the user and received as part of the receiving step 110. As shown in FIG. 8, the activity history link 851 may also be selected by a user in order to access a separate, and in various embodiments, more detailed, activity history display 1100 (as shown in FIG. 11) which may include, but is not limited to: a redemption status display 1110 (showing number of additional reports of physical activity required to reach the next redemption step 130); and a date display 1120 and corresponding summary display 1130 indicating the date and description of the physical activities that have been recently logged by the user in previous receiving steps 110.

As shown in FIG. 1, the method may further comprise step 120 for issuing a plurality of credits to the user in response to the received plurality of reports (as received in the receiving step 110). According to some embodiments of the present invention, step 120 may comprise issuing one credit per report of a physical activity regardless of the description of the physical activity (as input by a user in the description dialog box 814 of the reporting display 800, for example). According to some alternate embodiments, the issuing step 120 may comprise issuing a selected number of credits to the user in response to the received plurality of reports. For example, if the user inputs (via the description dialog box 814, for example) a report of a particularly beneficial physical activity (such as jogging, swimming, and/or cycling), step 120 may comprise issuing a specific number of credits to the user in response to the reported physical activity (corresponding to, for example, the intensity and/or predicted health benefit of a particular type of physical activity). Thus, in some embodiments, the issuing step 120 may be adjusted to issue a greater number of credits to a user for receiving a report of a particularly beneficial physical activity. Thus, the method embodiments of the present invention may be used to incentivize participation in particular types of physical activities by issuing enhanced numbers of credits for particular physical activities deemed most beneficial to a business entity or to those performing the method steps of the present invention. For example, a particular health insurer may determine that swimming may provide the best overall health benefits to users (because of its positive aerobic benefits and reduced impact on the joints or connective tissue of a participant). Thus, in order minimize health care costs incurred by users the health insurer may seek to incentivize participation of its insured users in swimming or other aquatic activities by issuing greater numbers of credits in the issuing step 120 in return for reports of participation in such aquatic physical activities. As described herein, in order to standardize reporting of particular activity types, the receiving step 110 (and the reporting display 800 generated in some embodiments) may comprise displaying a description dialog box 814 comprising a menu of pre-defined physical activity types (such as swimming, running, walking, cycling, and others) along with corresponding credit values that will be issued (as part of the subsequent issuing step 120, for example) in response to a received report of such activity types.

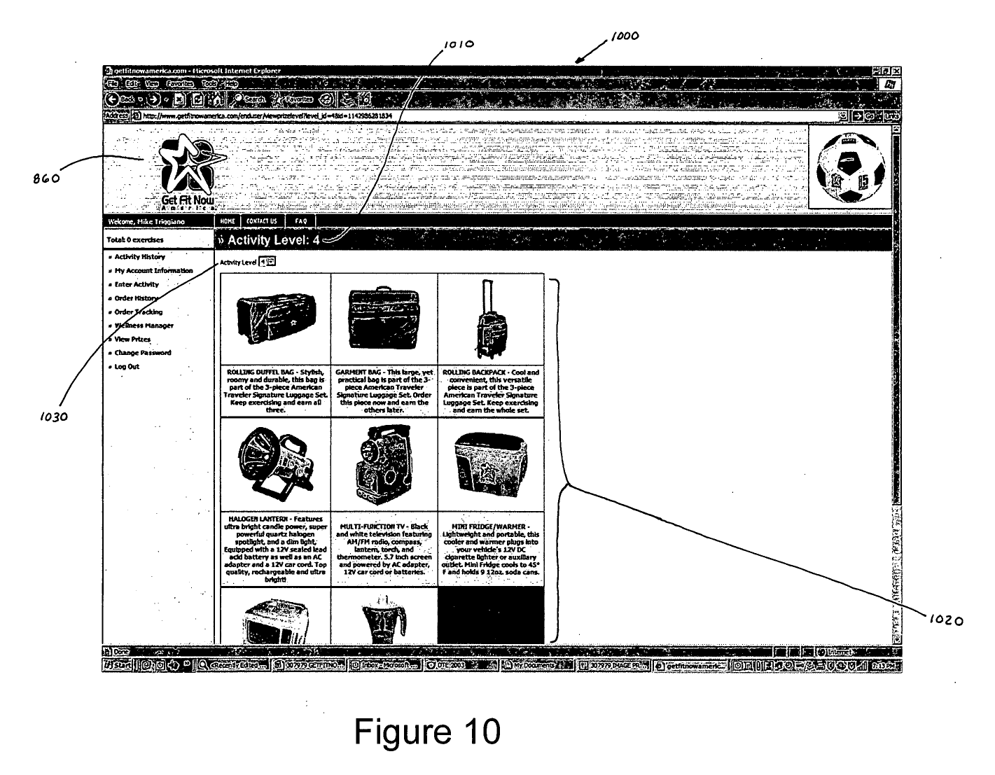

As further shown in FIG. 1, the method of the present invention may also comprise step 130 for redeeming a fixed number of the plurality of credits for a reward. In some embodiments, the user may “bank” credits that may be redeemable (in step 130, for example) for various rewards at various redemption categories 1010. The user may be required, in some embodiments, to engage in the redeeming step 130 after reporting a selected number of physical activities such that the user is ensured of receiving a branded reward (having a visible indicia and/or logo 860, as described further herein) after the selected number of reported physical activities. The “forced redemption” of issued credits required by some embodiments of the present invention may thus eliminate the accumulation of relatively value-less “credits” which the user may never redeem. The forced redemption step 130 requires the user to select a reward upon the completion of each redemption category 1010 (see FIG. 10, for example) such that that the user is continually motivated by the redemption and receipt of new rewards at each level.

The reward issued in the redeeming step 130 includes a visible indicia (such as a logo 860 such as that shown, for example, in the reporting display 800) thereon indicating the participation of the user in the plurality of physical activities so as to encourage the user to accurately report the participation in the plurality of physical activities. For example, the reward may comprise consumer goods including, but not limited to: apparel, sporting equipment, electronic equipment, appliances; or other goods having the visible indicia clearly visible thereon. The visible indicia may include a logo that indicates that the user has reported participation in a selected number of physical activities and has earned the reward in return for successful participation in an incentivized wellness and/or exercise program. Thus, the method of the present invention may encourage effective “self-policing” via the visible indicia (such as a logo 860) affixed to the rewards obtained in the redeeming step 860. The visible indicia may thus prevent users from cheating the method of the present invention by reporting physical activities in which the user did not actually engage. For example, because regular participation in physical activity generally results in visible changes in a participant (such as weight loss or maintenance of a healthy weight), if a user is collecting and using rewards decorated with the visible indicia (such as the logo 860) and is also failing to lose weight or maintain a healthy weight through exercise, the user will likely not continue to cheat the system through peer pressure (as others may recognize that the user is “cheating” the system).

According to some embodiments, the visual indicia may comprise not only a particular fitness program logo 860, but also a corporate logo corresponding to, for example, a business entity, such as a self-insured employer of the user or a health insurer at least partially responsible for the health care costs incurred by the user. In such embodiments, including the corporate logo as part of the visual indicia may not only provide additional advertising for the business entity but may also add to the “self-policing” advantages of the method of the present invention. For example, most insured individuals are aware that increasing health care costs (including rising co-pay amounts and insurance premiums, for example) are due at least in part to the failure of many individuals to maintain a healthy lifestyle including regular physical activity. Thus, a user wearing and/or using a reward marked with a particular business entity logo (such as a health insurer logo) may be incentivized to accurately report participation in physical activities for fear of being recognized as a potential “cheater” by another user of the same health insurer (whose own costs may be adversely affected by the increased costs associated with the unhealthy lifestyle choices of other users).

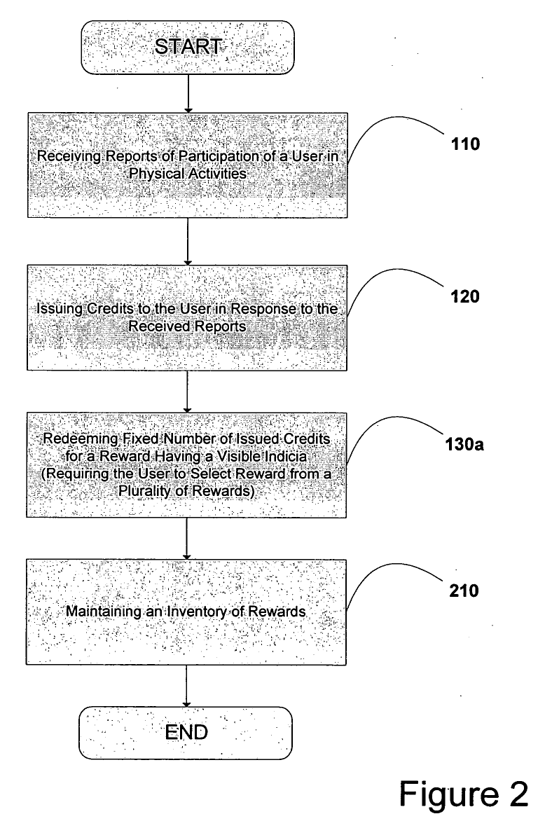

As described further herein, various embodiments of the present invention may also require the user to perform the redeeming step 130 in order to more effectively motivate the user to achieve specified fitness goals and to incentivize the establishment of a fitness “habit” by performing a selected number of consecutive and/or near-consecutive daily physical activities. For example, as shown in FIG. 2, the redeeming step 130 may comprise step 130a for requiring the user to select the reward from a plurality of rewards each having the visible indicia after receiving a selected number of the plurality of reports. For example, step 130a may comprise requiring the user to select the reward from a plurality of rewards after reporting a selected number of physical activities (and/or days in which the user engaged in a physical activity). The selected number may include any number of days or instances of reported physical activity believed to represent a milestone for establishing a positive habit of engaging in physical activity. For example, 25 days of physical activity may be set as the selected number at which step 130a requires the user to first select a reward from the plurality of rewards. According to some embodiments, a user may progress through several levels, or “redemption categories” (after a subsequent 25 day period or 25 reported physical activities) including rewards of increasing value and may then start over at the first level after redeeming (see steps 130/130a) a reward from the highest-valued redemption category (such as “category 4” shown generally in the redemption display 1000 of FIG. 10).

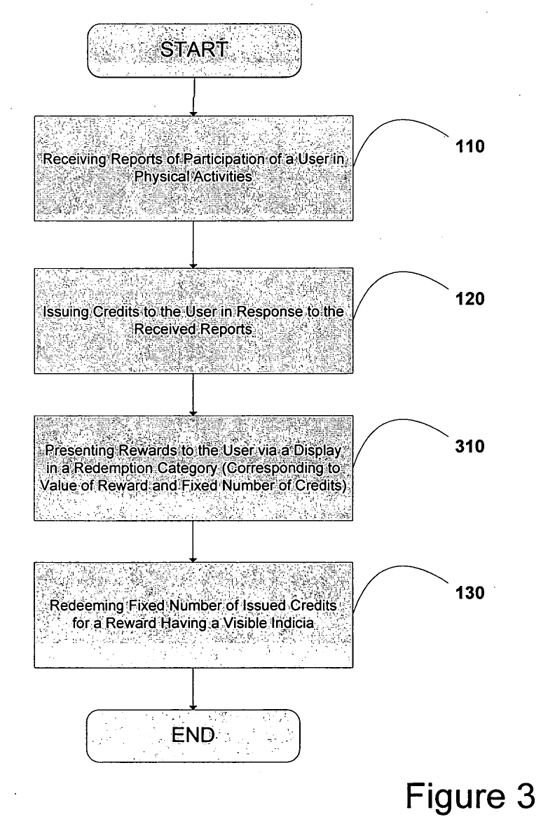

Various method embodiments of the present invention may also comprise generating a redemption display 1000 (as shown in FIG. 10) for displaying rewards that the user may be required to choose from in the redemption step 130a based on the redemption category achieved by the user. For example, as shown in FIG. 3, various method embodiments of the present invention may further comprise step 310 for presenting the reward to the user via a display for displaying the reward in a redemption category 1010 corresponding to, in some embodiments, a value of the reward and the fixed number of the plurality of credits. The redemption display 1000, shown in FIG. 10, may display a rewards listing 1020 including the plurality of rewards available at the “activity level 4” (corresponding to, for example, 100 days or 100 reported instances of participation in a physical activity). The redemption display 1000 may also comprise an activity level indicator 1010 (corresponding to a “redemption category,” for example) for informing the user of the activity level or redemption category achieved by the most recent received report of physical activity. According to some embodiments, the redemption display 1000 may also comprise an activity level selector 1030 comprising, for example, a drop down menu such that a user may select and view the rewards available at the other activity levels (or redemption categories).

The method of the present invention may also comprise various steps for performing the receiving 110, issuing 120, and redeeming 130/130a steps described herein on behalf of a business entity and performing additional steps for providing a turn-key physical activity incentive program to a business entity that may be offered directly to users that may be already affiliated with the business entity (as, for example, employees, insured individuals, and/or clients). As shown in FIG. 2, various method embodiments of the present invention may comprise step 210 for maintaining an inventory of the plurality of rewards. According to such embodiments, the redeeming step 130a may further comprise requiring the user to select the reward from a subset of the plurality of rewards wherein the subset of the plurality of rewards is available in the maintained inventory. Thus, the redeeming 130 and inventory maintaining steps 210 may automatically display (via the redemption display 1000, for example) only that rewards listing 1020 corresponding to rewards that are currently available in the maintained inventory. By maintaining and/or automatically updating an inventory of available rewards 1020 in each redemption category 1010 as part of step 210, the method of the present invention may avoid disappointing and potentially disheartening offers of rewards that are not immediately available for redemption in the redemption step 130.

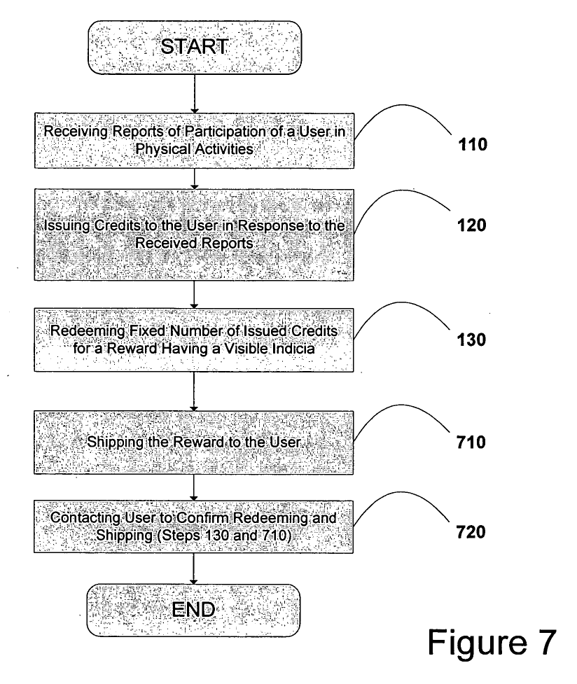

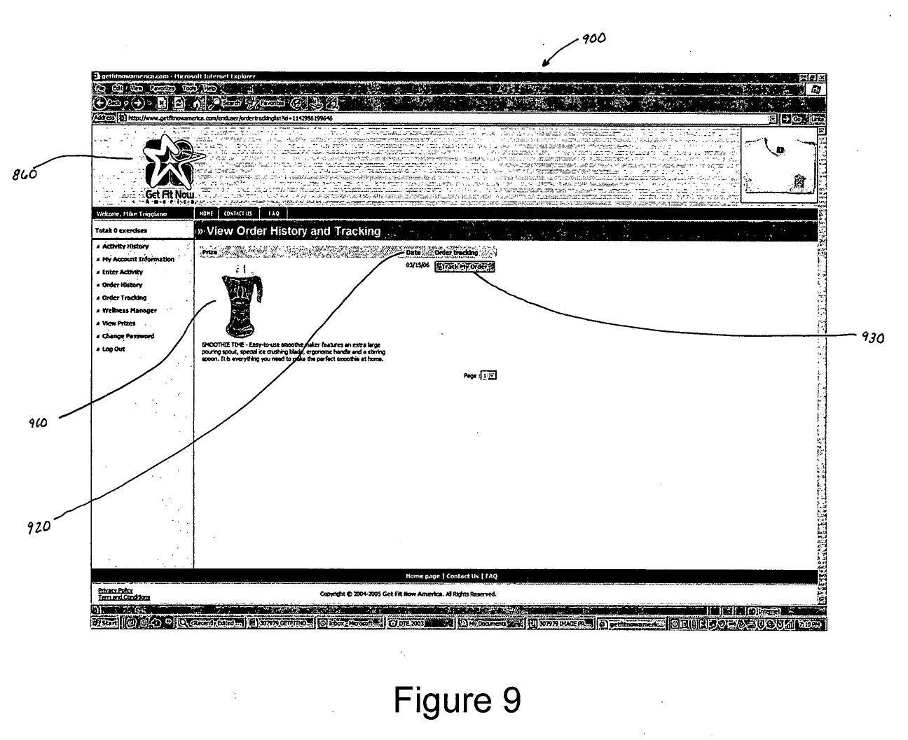

As shown in FIG. 7, various methods of the present invention may also comprise additional steps for administering the redemption step 130 and for ensuring that the rewards redeemed by the user are actually received by the user. For example, various method embodiments of the present invention may further comprise step 710 for shipping the reward to the user on behalf of the business entity. The shipping step 710 may comprise, for example, contacting an electronic shipping portal operated by a third-party shipping company and/or postal service for initiating the production of a shipping label and for submitting electronic payment of shipping and handling costs so as to expedite the shipping of the selected reward 910 (see, for example, the order tracking display 900 shown in FIG. 9). The shipping step 710 may also comprise receiving a tracking number from a third-party shipping company and/or postal service for tracking the shipment of the selected reward 910 to the user (as described further herein with respect to the contacting step 720 shown in FIG. 7).

Some method embodiments further comprise step 720 for contacting the user to confirm the redeeming 130 and shipping 710 steps. The contacting step 720 may include, for example, sending an electronic mail message to the user and/or contacting the user via telephone to confirm the timely receipt of the redeemed reward. The contacting step 720 may also be accomplished, for example, via a web page display such as the order tracking display 900 shown in FIG. 9. The order tracking display 900 may be generated by a server computer device responsible for performing the various method steps described herein and may be interactively displayed to a user interface (such as a user's personal computer) via a network such as the internet. As described further herein, a user may log onto a website (using a user ID and assigned password, for example) to access the order tracking display 900 for tracking the status of a selected reward 910. The order tracking display 900 may include a detailed description and photo of the selected reward 910, a date display 920 (indicating, for example, the date on which the redemption step 130 occurred), and an order tracking button 930 (which may, in some embodiments, link the user directly to a third party shipping company and/or postal service website for tracking the shipment of the selected reward 910). For example, a shipment tracking number corresponding to the selected reward 910 received as part of step 710 may be utilized in various method embodiments to automatically request tracking information for the shipment of the selected reward 910 upon a user selection of the order tracking button 930 included in the order tracking display 900. The inventory maintenance 210, shipping 710, and confirmation 720 steps performed according to various method embodiments of the present invention may thus provide a substantially hands-off maintenance, redemption, and shipping system by which a business entity may offer a physical activity incentive program to users without having to perform and monitor the administrative and technical steps associated therewith.

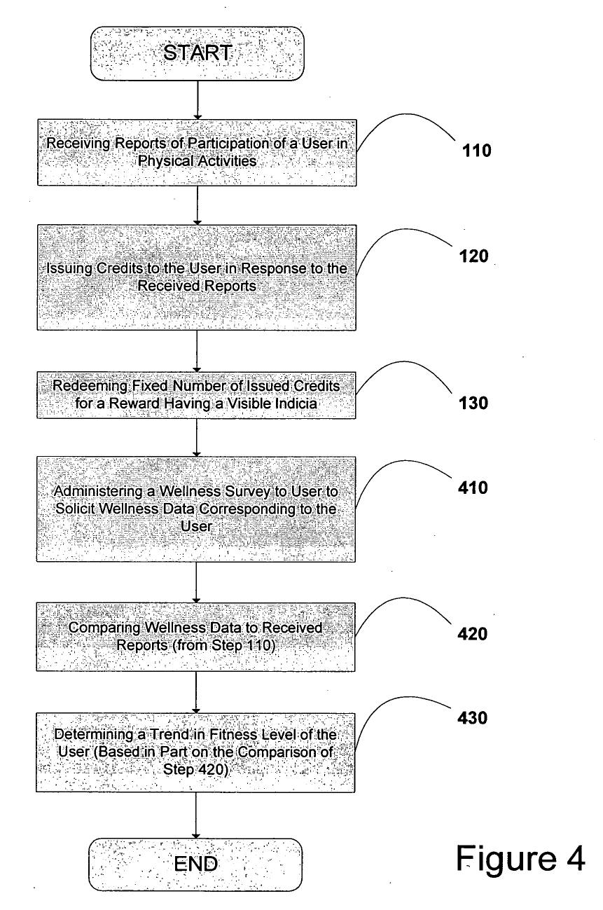

Additional embodiments of the present invention may further comprise steps for correlating the received reports of participation in physical activities by a particular user to other user wellness data to determine an overall trend in a particular user's fitness level and utilizing the determined trend to estimate the reduction in health care costs achieved by the user's participation in the physical activities incentivized by the various embodiments of the present invention. For example, as shown in FIG. 4, various method embodiments of the present invention may further comprise: step 410 for administering a wellness survey to the user so as to solicit wellness data corresponding to the user; step 420 for comparing the wellness data to the received plurality of reports of the participation of the user in the plurality of physical activities; and step 430 for determining a trend in a fitness level of the user based at least in part on the comparison (see step 420) of the wellness data and the received plurality of reports.

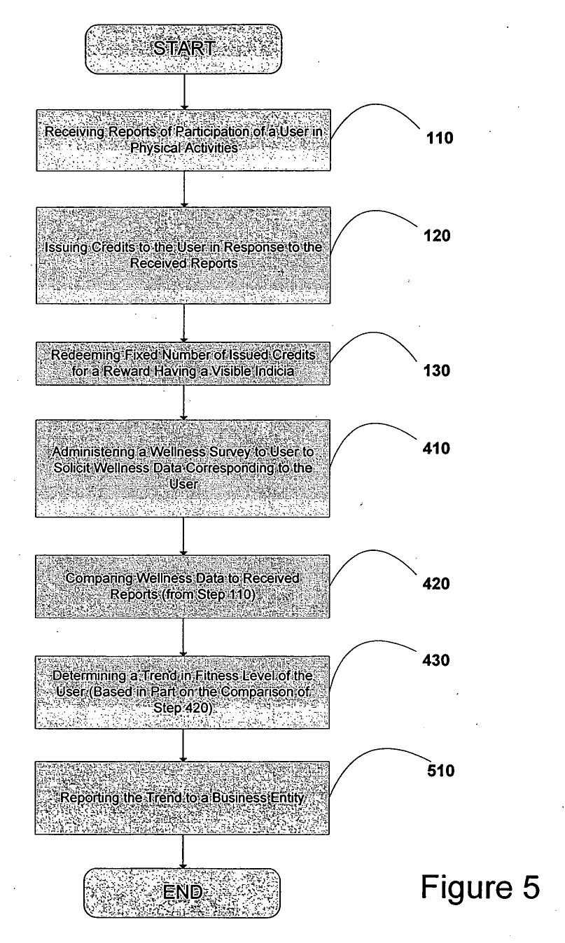

The wellness survey administering step 410 may be accomplished in some embodiments by a website display provided to the user as part of the redeeming step 130 described further herein. According to some embodiments, the wellness survey may be administered in step 410 by sending a periodic electronic mail (for example, every four to six months) to the user in order to solicit wellness data corresponding to the user. According to other embodiments, the survey may be administered prior to redeeming (see step 130 described further herein) issued credits in exchange for a selected reward 910 (see FIG. 9). For example, step 410 may comprise presenting (via a pop-up display, for example) a wellness survey to the user to solicit wellness data corresponding to the user during each redemption step 130/130a. The pop-up display may comprise dialogue boxes for receiving a variety of wellness data that may include, but are not limited to: body mass index (BMI); weight; height; cholesterol level; blood pressure; resting heart rate; and combinations of such wellness data. In the comparing step 420, when a user reaches each redemption category 1010 (see FIG. 10, for example) and/or at a pre-selected time interval (such as a four to six month interval between surveys) embodiments of the present invention may compare, the user's fitness level (as indicated by the wellness data solicited in step 410) to the expected level of fitness that should be achieved by a user having reported the physical activities logged during the receiving step 110. In addition, step 430 may comprise determining a trend in a fitness level of the user based at least in part on the comparison (see step 420) of the wellness data and the received plurality of reports. For example, if both the solicited wellness data and the received reports of physical activity correlate highly to indicate a high level of physical activity, step 430 may comprise determining a generally upward trend in fitness level. However, in examples wherein the reported level of physical activity is generally high, but the wellness data indicates a general plateau or decline in the user's fitness level, step 430 may comprise determining no general trend in the user's fitness level (i.e. a fitness “plateau”). In some additional embodiments, as shown generally in FIG. 5, the method may further comprise step 510 for reporting the determined trend to the business entity. Thus, the business entity may have an opportunity to contact the user (who, in many cases, is an employee or is insured by the business entity) to offer medical support and/or fitness guidelines to correct a generally downward trend in fitness level and/or help to provide upward momentum to a user experiencing a fitness “plateau” or in some cases, a downward trend in overall fitness level.

According to some additional embodiments, the method may also comprise steps for receiving an information data set corresponding to the user from the business entity. For example, in many cases, the users (such as insured individuals and/or employees) have an existing relationship with the business entity that may have required the user to provide various data that may be relevant to the user's overall and/or baseline fitness level and/or medical history. Thus, some method embodiments may comprise receiving an information data set corresponding to the user from the business entity wherein data within the information data set may include, but is not limited to: user identification information; user medical history; user family medical history; user baseline wellness data; and combinations of such data. Data within the information data set may be utilized for the more effective performance of the trend determining step 430 and the health care cost reduction estimation step 620 described further herein.

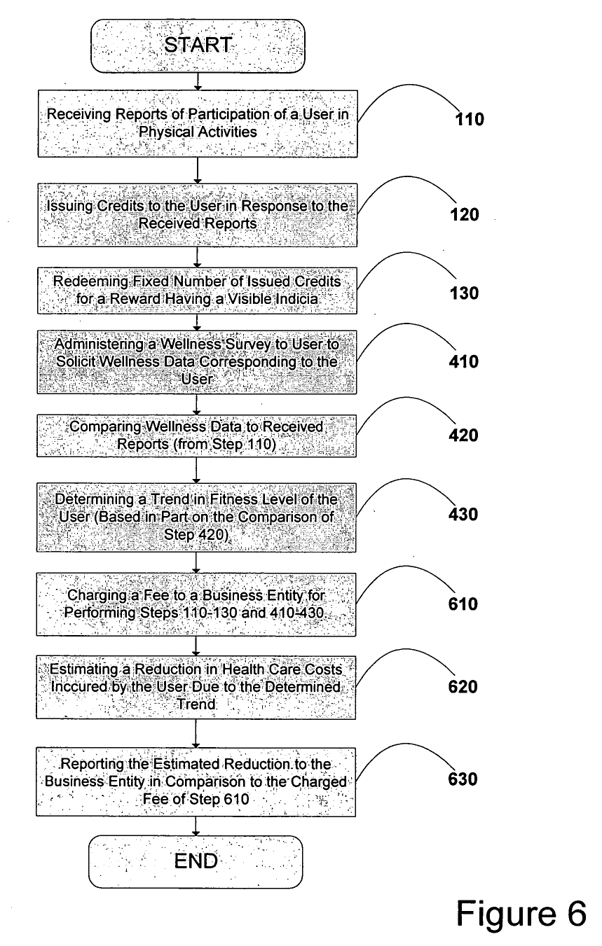

As described herein, the business entity may, in many cases, be at least partially responsible for health care costs incurred by the user (as a self-insured employer and/or a health insurer, for example). Thus, the business entity may be especially concerned with health care costs incurred by particular users and reducing such costs. Various method embodiments of the present invention, as shown in FIG. 6 may further comprise step 610 for charging a service fee to the business entity for performing the receiving 110, issuing 120, redeeming 130/130a, administering 410, comparing 420 and determining 430 steps. In addition, the method may also further comprise step 620 for estimating a reduction in the health care costs incurred by the user using the trend in fitness level determined as part of step 430.

The method may also comprise step 630 for reporting the estimated reduction in health care costs to the business entity such that the business entity that the estimated reduction is comparable to the service fee charged to the business entity as part of step 610. Thus, according to various embodiments of the method of the present invention, the business entity may be kept updated as to the estimated savings in health care costs attained by the various users' participation in the incentivized fitness program administered using steps 110-130 (for example).

In addition to providing apparatus and methods, the present invention also provides computer program products for performing the operations described above. The computer program products have a computer readable storage medium having computer readable program code embodied in the medium. The computer readable storage medium may be part of a storage device and may implement the computer readable program code to perform the above discussed operations.

In this regard, FIGS. 1-7 are block diagram illustrations of methods and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus implement the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instructions which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of instructions for performing the specified functions, combinations of steps for performing the specified functions and program instructions for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for encouraging participation in a physical activity and accurate reporting of participation in the physical activity to a business entity, the method comprising:
receiving a plurality of reports of a participation of a user in a corresponding plurality of physical activities;
issuing a plurality of credits to the user in response to the received plurality of reports;
redeeming a fixed number of the plurality of credits for a reward, the reward having a visible indicia thereon indicating the participation of the user in the plurality of physical activities so as to encourage the user to accurately report the participation in the plurality of physical activities.

2. A method according to claim 1, wherein the redeeming step comprises requiring the user to select the reward from a plurality of rewards each having the visible indicia after receiving a selected number of the plurality of reports.

3. A method according to claim 2, further comprising maintaining an inventory of the plurality of rewards and wherein the redeeming step further comprises requiring the user to select the reward from a subset of the plurality of rewards wherein the subset of the plurality of rewards is available in the maintained inventory.

4. A method according to claim 1, further comprising presenting the reward to the user via a display for displaying the reward in a redemption category corresponding to a value of the reward and the fixed number of the plurality of credits.

5. A method according to claim 1, further comprising shipping the reward to the user on behalf of the business entity.

6. A method according to claim 5, further comprising contacting the customer to confirm the redeeming and shipping steps.

7. A method according to claim 1, further comprising:
administering a wellness survey to the user so as to solicit wellness data corresponding to the user;
comparing the wellness data to the received plurality of reports of the participation of the user in the plurality of physical activities; and
determining a trend in a fitness level of the user based at least in part on the comparison of the wellness data and the received plurality of reports.

8. A method according to claim 7, further comprising reporting the trend to the business entity.

9. A method according to claim 7, wherein the business entity is at least partially responsible for health care costs incurred by the user, the method further comprising estimating a reduction in the health care costs incurred by the user using the determined trend.

10. A method according to claim 9, further comprising:
charging a service fee to the business entity for performing the receiving, issuing, redeeming, administering, comparing and determining steps; and
reporting the estimated reduction in health care costs to the business entity such that the business entity that the estimated reduction is comparable to the service fee.

11. A method according to claim 7, wherein the wellness data is selected from the group consisting of:
body mass index (BMI);
weight;
height;
cholesterol level;
blood pressure;
resting heart rate; and
combinations thereof.

12. A method according to claim 1, further comprising receiving an information data set corresponding to the user from the business entity.

13. A method according to claim 12, wherein data within the information set is selected from the group consisting of:
user identification information;
user medical history;
user family medical history;
user baseline wellness data; and
combinations thereof.

14. A computer program product for encouraging participation in a physical activity and accurate reporting of participation in the physical activity to a business entity, the computer program product comprising a computer-readable storage medium having computer-readable program code instructions stored therein comprising:
a first set of computer instructions for receiving a plurality of reports of a participation of a user in a corresponding plurality of physical activities;
a second set of computer instructions for issuing a plurality of credits to the user in response to the received plurality of reports;
a third set of computer instructions for redeeming a fixed number of the plurality of credits for a reward, the reward having a visible indicia thereon indicating the participation of the user in the plurality of physical activities so as to encourage the user to accurately report the participation in the plurality of physical activities.

15. A computer program product according to claim 14, wherein the third set of computer instructions for redeeming comprises a fourth set of computer instructions for requiring the user to select the reward from a plurality of rewards each having the visible indicia after receiving a selected number of the plurality of reports.

16. A computer program product according to claim 15, further comprising a fifth set of computer instructions for maintaining an inventory of the plurality of rewards and wherein the fourth set of computer instructions for requiring comprises requiring the user to select the reward from a subset of the plurality of rewards wherein the subset of the plurality of rewards is available in the maintained inventory.

17. A computer program product according to claim 14, further comprising a sixth set of computer instructions for presenting the reward to the user via a display for displaying the reward in a redemption category corresponding to a value of the reward and the fixed number of the plurality of credits.

18. A computer program product according to claim 14, further comprising a seventh set of computer instructions for shipping the reward to the user on behalf of the business entity.

19. A computer program product according to claim 18, further comprising an eighth set of computer instructions for contacting the customer to confirm the redeeming and shipping of the reward.

20. A computer program product according to claim 14, further comprising:
a ninth set of computer instructions for administering a wellness survey to the user so as to solicit wellness data corresponding to the user;
a tenth set of computer instructions for comparing the wellness data to the received plurality of reports of the participation of the user in the plurality of physical activities; and
an eleventh set of computer instructions for determining a trend in a fitness level of the user based at least in part on the comparison of the wellness data and the received plurality of reports.

21. A computer program product according to claim 20, further comprising a twelfth set of computer instructions for reporting the trend to the business entity.

22. A computer program product according to claim 20, wherein the business entity is at least partially responsible for health care costs incurred by the user, the computer program product further comprising a thirteenth set of computer instructions for estimating a reduction in the health care costs incurred by the user using the determined trend.

23. A computer program product according to claim 22, further comprising
a fourteenth set of computer instructions for charging a service fee to the business entity for performing the computer program product; and
a fifteenth set of computer instructions for reporting the estimated reduction in health care costs to the business entity such that the estimated reduction is comparable to the service fee.

24. A computer program product according to claim 20, wherein the wellness data solicited by the ninth set of computer instructions is selected from the group consisting of:
body mass index (BMI);
weight;
height;
cholesterol level;
blood pressure;
resting heart rate; and
combinations thereof.

25. A computer program product according to claim 14, further comprising a sixteenth set of computer program instructions for receiving an information data set corresponding to the user from the business entity.

26. A computer program product according to claim 25, wherein data within the information set is selected from the group consisting of:
user identification information;
user medical history;
user family medical history;
user baseline wellness data; and
combinations thereof.
